(19) United States
(12) Patent Application Publication
(10) Pub. No.: US 2009/0138249 A1
(43) Pub. Date: May 28, 2009

(54) DEFINING OPERATIONAL ELEMENTS IN A BUSINESS PROCESS MODEL

(75) Inventors: Pablo D. Irassar, Markham (CA); Simon K. Johnston, Siler City, NC (US)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(73) Assignee: INTERNATIONAL BUSINESS MACHINES CORPORATION, Armonk, NY (US)

(21) Appl. No.: 11/946,530

(22) Filed: Nov. 28, 2007

(51) Int. Cl. G06G 7/48

(52) U.S. Cl. 703/6

(57) ABSTRACT

Embodiments of the invention provide a method, system and computer program product for rendering a process model through a configuration of a unitary operational element in the process modeling data processing system. The method can include parsing semantic elements in a semantic process model and identifying different types for the semantic elements as well as different connections amongst the semantic elements in the semantic process model. The method further can include initializing a visual model to include instances of a unitary operational element, and for each of the semantic elements, an instance of a unitary operational element can be configured in the visual model with zero or more inbound and outbound connections according to an identified type and connecting paths between respective outbound and inbound connections of different instances of the unitary operational element based upon the different connections amongst the semantic elements. Finally, the visual model can be displayed.

### BACKGROUND OF THE INVENTION

1. Field of the Invention

The present invention relates to the field of modeling and simulation and more particularly to managing process model notations.

2. Description of the Related Art

Process modeling and simulation relates to the modeling and simulation of dynamic or static systems, which can include, but are not limited to, enterprise management systems, engineering systems, networked information technology systems, utility systems, utility computing systems, autonomic computing systems, on-demand systems, electric power grids, biological systems, medical systems, weather systems, financial market systems, and business process systems. Such systems can be modeled and simulated for a variety of purposes including monitoring, analysis, control, design, simulation, and management.

A process model is an abstract description of a process such as a business process or any other process related to the lifecycle of a system. The abstract description of the process model can include sufficient detail required by a simulation engine for exercising the process model with one or more scenarios to determine a likely outcome. Process models generally specify one or more tasks or activities of a process and the relationship between the different tasks or activities. As part of the model, one or more events or conditions leading to the transition from one task or activity to the next can be specified. Models generally are expressed according to a specific format. Exemplary formats include Activity Decision Flow (ADF) Unified Modeling Language (UML) activity diagrams, and the Business Process Execution Language (BPEL), to name only a few.

Most process modeling notations provide for a set of nodes connected by flow-of-control and in some cases flow-of-data. These nodes correspond to a set of behavioral elements that have been in use from flowcharts onward into modern business process modeling. A core set of node types include tasks, decisions, merges, forks and joins. Tasks are nodes where actions are performed and decisions are nodes where decisions are performed, and the flow of control of a process branches along mutually exclusive paths. Merges are nodes where branches in a process are brought together. Finally, forks are nodes where the flow of control of a process forks into multiple, parallel, paths, while joins are nodes where the parallel flows of control from a previous fork are brought together.

In general, languages and models define particular types of nodes for these concepts and yet support general-purpose concepts such as connectability, naming, and so forth. This clear separation of action from non-action nodes leads to cases where logically an action has distinct outcomes but requires a combination of action and decision and a later merge to model this case explicitly. And, while in some cases it is important to model such decisions as explicit and separate nodes it forces a style that is not appropriate in all cases. Secondly the operational semantics of action and non-action nodes are similarly defined separately; in the case of action some behavior, specified by the user, is executed whereas the semantics of non-action nodes is defined usually by the language designer in some specification.

### BRIEF SUMMARY OF THE INVENTION

Embodiments of the present invention address deficiencies of the art in respect to process modeling and provide a novel and non-obvious method, system and computer program product for rendering a process model through a configuration of a unitary operational element in the process modeling data processing system. In one aspect of the embodiment, a method for rendering a process model through a configuration of a unitary operational element in the process modeling data processing system can include parsing semantic elements in a semantic process model and identifying different types for the semantic elements as well as different connections amongst the semantic elements in the semantic process model.

The method further can include initializing a visual model to include instances of a unitary operational element. Thereafter, for each of the semantic elements, an instance of a unitary operational element can be configured in the visual model with zero or more inbound and outbound connections according to an identified type and connecting paths between respective outbound and inbound connections of different instances of the unitary operational element based upon the different connections amongst the semantic elements. Finally, the method can include displaying the visual model in the process modeling data processing system.

Identifying different types for the semantic elements as well as different connections amongst the semantic elements in the semantic process model can include identifying task nodes and decision nodes for the semantic elements as well as different connections amongst the task nodes and decision nodes in the semantic process model. Also, identifying different types for the semantic elements as well as different connections amongst the semantic elements in the semantic process model can include identifying both forked connections and joined connections for parallel paths between selected ones of the task nodes and decision nodes. Yet further, identifying different types for the semantic elements as well as different connections amongst the semantic elements in the semantic process model can include identifying merged connections of independent paths between selected ones of the task nodes and decision nodes.

Configuring an instance of a unitary operational element in the visual model with zero or more inbound and outbound connections according to an identified type can include configuring a task instance of a unitary operational element in the visual model with a single outbound connection to correspond to a task node in the semantic process model. Similarly, configuring an instance of a unitary operational element in the visual model with zero or more inbound and outbound connections according to an identified type can include configuring a decision instance of a unitary operational element in the visual model with at least two outbound connections to correspond to a decision node in the semantic process model. Yet further, configuring an instance of a unitary operational element in the visual model with zero or more inbound and outbound connections according to an identified type can include configuring a merge instance of a unitary operational element in the visual model with multiple inbound connections to correspond to a merge node in the semantic process model.

In another embodiment of the invention, a process modeling data processing system can be provided. The system can include a process modeler executing in an operating environment provided by a host computing platform. The system also can include unitary element configuration logic. The logic can include program code enabled to convert a semantic process model into a visual process model by configuring different instances of a unitary operational element with different inbound and outbound connections to represent different node types in the semantic model. In particular, the different instances of the unitary operational element can include a task instance and a decision instance, as well as a merge instance.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a schematic illustration of a process modeling data processing system configured to model a process through a configuration of a unitary operational element;

FIG. 2 is a block diagram illustrating multiple different configurations of a unitary operational element for use in the process modeling data processing system of FIG. 1; and,

FIG. 3 is a flow chart illustrating a method for rendering a process model through a configuration of a unitary operational element in the process modeling data processing data processing system of FIG. 1.

### DETAILED DESCRIPTION OF THE INVENTION

Embodiments of the present invention provide a method, system and computer program product for rendering a process model through a configuration of a unitary operational element in a process modeling data processing system. In accordance with an embodiment of the present invention, a unitary operational element for a business process model can be configured for each action and non-action in the process model. Connections flowing into and out of each unitary operational element can determine a type of operational element. In this regard, when configured with a single outbound connection, a unitary operational element can be an action node, whereas two or more outbound connections flowing from a unitary operational element can be a decision node. In this way, the visualization and underlying representation of a process model can be simplified through the configuration of a single operational element.

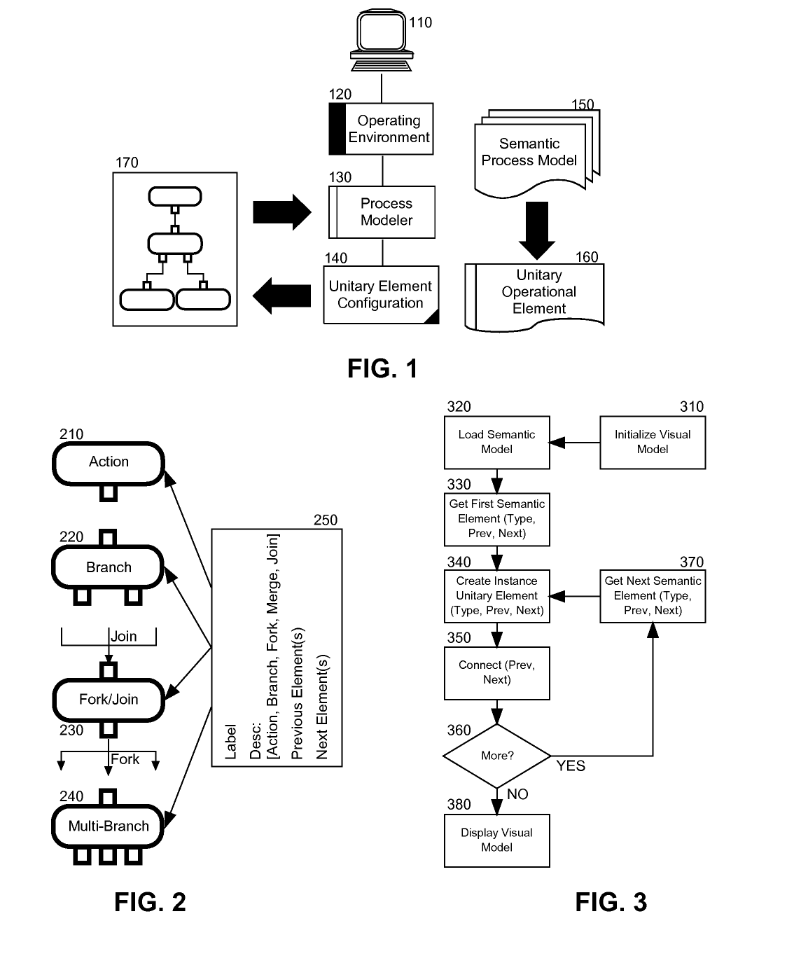

In further illustration, FIG. 1 is a schematic illustration of a process modeling data processing system configured to model a process through a configuration of a unitary operational element. The system can include a host computing platform 110 providing an operating environment 120, for instance an operating system or virtual machine. A process modeler 130 can execute in the operating environment 120, for example the WebSphere™ Business Modeler family of modeling products manufactured by International Business Machines Corporation of Armonk, N.Y., United States of America.

Unitary element configuration logic 140 can be coupled to the process modeler 130. The unitary element configuration logic 140 can include program code enabled to parse a semantic form of a process model 150 to identify different tasks, decisions, merges, forks and joins. The program code further can be enabled to configure different instances of a unitary operational element 160 and the connections therebetween to accommodate the identified different tasks, decisions, merges, forks and joins in the semantic process model 150 in order to produce a visual process model 170 of nodes formed from a visual representation of different configurations of different instances the unitary operational element 160.

In yet further illustration of the different configurations of different instances of the unitary operational element 160, FIG. 2 is a block diagram illustrating multiple different configurations of a unitary operational element for use in the process modeling data processing system of FIG. 1. As shown in FIG. 2, instances of a unitary operational element 210, 220, 230, 240 can be configured with different connections both inbound and outbound. The nature and number of the connections can define whether an instance of the unitary operational element 210, 220, 230, 240 is representative of a task node (an action node) 210, a decision node 220, 240, a join node 230, a merge node (not shown) or a fork node (node shown). An underlying data structure 250 for an instance of the unitary operational element 210, 220, 230, 240 can include a description of the type of node as well as an indication of zero or more inbound connections and zero or more outbound connections.

In this regard, an instance of a unitary operational element 210, 220, 230, 240 providing for a single outbound connection is a task node. By comparison, an instance of a unitary operational element 210, 220, 230, 240 providing for multiple outbound connections is indicative of a decision node. In the latter circumstance, only two outbound connections reflect a binary choice in the decision node, whereas multiple different outbound connections reflects a probabilistic choice amongst the different outbound connections. Finally, an instance of a unitary operational element 210, 220, 230, 240 providing for two or more inbound connections is a merge node merging separate independent paths in a process model. Of note multiple inbound paths into a single inbound connection reflects a join of previously forked, parallel paths in a process model and multiple outbound paths from a single outbound connection reflects a fork into multiple different parallel paths in a process model.

In even yet further illustration, FIG. 3 is a flow chart illustrating a method for rendering a process model through a configuration of a unitary operational element in the process modeling data processing system of FIG. 1. Beginning in block 310, a visual model for a semantic process model can be initialized to store a set of visual representations of different instances of a unitary operational element and in block 320, a semantic model can be loaded for processing. In block 330, a first semantic element can be identified in the semantic model. The semantic element can include a node type such as a task, decision, fork, branch, merge or join. The semantic element further can include an indication of connections to one or more upstream semantic elements, one or more downstream elements, or both recognizing that ordinarily an initial semantic element in a semantic model will have no upstream elements and, conversely, a final semantic element in a semantic model will have no downstream elements.

In block 340, an instance of the unitary operational element can be created in the visual model for the identified semantic element and one or more inbound connections, outbound connections, or both can be defined for the instance of the unitary operational element depending upon the type of the identified semantic element and the indication of connections to one or more upstream semantic elements, one or more downstream elements, or both. Thereafter, in block 350, paths can be created between the connections of the instance of the unitary operational element and the upstream semantic elements and downstream elements, as the case may be. In decision block 360, if addition semantic elements remain to be processed in the semantic model, the method can repeat through block 370 with a next identified semantic element in the process model. In decision block 360, when no further semantic elements remain, in block 380 the visual model can be displayed.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. A method for rendering a process model through a configuration of a unitary operational element in the process modeling data processing system, the method comprising:
parsing semantic elements in a semantic process model;
identifying different types for the semantic elements as well as different connections amongst the semantic elements in the semantic process model;
initializing a visual model to include instances of a unitary operational element;
for each of the semantic elements, configuring an instance of a unitary operational element in the visual model with zero or more inbound and outbound connections according to an identified type and connecting paths between respective outbound and inbound connections of different instances of the unitary operational element based upon the different connections amongst the semantic elements; and,
displaying the visual model in the process modeling data processing system.

2. The method of claim 1, wherein identifying different types for the semantic elements as well as different connections amongst the semantic elements in the semantic process model, comprises identifying task nodes and decision nodes for the semantic elements as well as different connections amongst the task nodes and decision nodes in the semantic process model.

3. The method of claim 2, wherein identifying different types for the semantic elements as well as different connections amongst the semantic elements in the semantic process model, further comprises identifying both forked connections and joined connections for parallel paths between selected ones of the task nodes and decision nodes for the semantic elements in the semantic process model.

4. The method of claim 2, wherein identifying different types for the semantic elements as well as different connections amongst the semantic elements in the semantic process model, further comprises identifying merged connections of independent paths between selected ones of the task nodes and decision nodes for the semantic elements in the semantic process model.

5. The method of claim 1, wherein configuring an instance of a unitary operational element in the visual model with zero or more inbound and outbound connections according to an identified type, comprises configuring a task instance of a unitary operational element in the visual model with a single outbound connection to correspond to a task node in the semantic process model.

6. The method of claim 1, wherein configuring an instance of a unitary operational element in the visual model with zero or more inbound and outbound connections according to an identified type, comprises configuring a decision instance of a unitary operational element in the visual model with at least two outbound connections to correspond to a decision node in the semantic process model.

7. The method of claim 1, wherein configuring an instance of a unitary operational element in the visual model with zero or more inbound and outbound connections according to an identified type, comprises configuring a merge instance of a unitary operational element in the visual model with multiple inbound connections to correspond to a merge node in the semantic process model.

8. A process modeling data processing system comprising:
a process modeler executing in an operating environment provided by a host computing platform; and,
unitary element configuration logic comprising program code enabled to convert a semantic process model into a visual process model by configuring different instances of a unitary operational element with different inbound and outbound connections to represent different node types in the semantic model.

9. The system of claim 8, wherein the different instances of the unitary operational element comprise a task instance and a decision instance.

10. The system of claim 8, wherein the different instances of the unitary operational element further comprise a merge instance.

11. The system of claim 8, wherein an instance of the unitary operational element with a single inbound connection coupled to multiple different upstream instances of the unitary operational element is a join instance of the unitary operational element.

12. The system of claim 8, wherein an instance of the unitary operational element with a single outbound connection coupled to multiple different downstream instances of the unitary operational element is a fork instance of the unitary operational element.

13. A computer program product comprising a computer usable medium embodying computer usable program code for rendering a process model through a configuration of a unitary operational element in the process modeling data processing system, the computer program product comprising:
computer usable program code for parsing semantic elements in a semantic process model;
computer usable program code for identifying different types for the semantic elements as well as different connections amongst the semantic elements in the semantic process model;
computer usable program code for initializing a visual model to include instances of a unitary operational element;
computer usable program code for configuring for each of the semantic elements an instance of a unitary operational element in the visual model with zero or more inbound and outbound connections according to an identified type and connecting paths between respective outbound and inbound connections of different instances of the unitary operational element based upon the different connections amongst the semantic elements; and,
computer usable program code for displaying the visual model in the process modeling data processing system.

14. The computer program product of claim 13, wherein the computer usable program code for identifying different types for the semantic elements as well as different connections amongst the semantic elements in the semantic process model, comprises computer usable program code for identifying task nodes and decision nodes for the semantic elements as well as different connections amongst the task nodes and decision nodes in the semantic process model.

15. The computer program product of claim 14, wherein the computer usable program code for identifying different types for the semantic elements as well as different connections amongst the semantic elements in the semantic process model, further comprises computer usable program code for identifying both forked connections and joined connections for parallel paths between selected ones of the task nodes and decision nodes for the semantic elements in the semantic process model.

16. The computer program product of claim 14, wherein the computer usable program code for identifying different types for the semantic elements as well as different connections amongst the semantic elements in the semantic process model, further comprises computer usable program code for identifying merged connections of independent paths between selected ones of the task nodes and decision nodes for the semantic elements in the semantic process model.

17. The computer program product of claim 13, wherein the computer usable program code for configuring an instance of a unitary operational element in the visual model with zero or more inbound and outbound connections according to an identified type, comprises computer usable program code for configuring a task instance of a unitary operational element in the visual model with a single outbound connection to correspond to a task node in the semantic process model.

18. The computer program product of claim 13, wherein the computer usable program code for configuring an instance of a unitary operational element in the visual model with zero or more inbound and outbound connections according to an identified type, comprises computer usable program code for configuring a decision instance of a unitary operational element in the visual model with at least two outbound connections to correspond to a decision node in the semantic process model.

19. The computer program product of claim 13, wherein the computer usable program code for configuring an instance of a unitary operational element in the visual model with zero or more inbound and outbound connections according to an identified type, comprises computer usable program code for configuring a merge instance of a unitary operational element in the visual model with multiple inbound connections to correspond to a merge node in the semantic process model.
